(19) United States
(12) Patent Application Publication
(10) Pub. No.: US 2011/0119190 A1
(43) Pub. Date: May 19, 2011

(54) ANONYMOUS TRANSACTION PAYMENT SYSTEMS AND METHODS

(76) Inventor: Magid Joseph Mina, Los Angeles, CA (US)

(21) Appl. No.: 12/948,649

(22) Filed: Nov. 17, 2010

Related U.S. Application Data
(60) Provisional application No. 61/262,449, filed on Nov. 18, 2009.

(51) Int. Cl. G06Q 20/00

(52) U.S. Cl. 705/44

(57) ABSTRACT

Disclosed are methods, apparatus, systems, and non-transitory, tangible computer-readable media associated with use of transaction authorization codes to each of the parties involved in a buying and selling transaction. In various embodiments, the transaction authorization code(s) may be exchanged between parties, and once confirmed or validated, the transaction may be consummated. In one embodiment, the transaction authorization code may conceal personal and/or financial information about a party with whom the code is associated. In various embodiments, transaction authorization codes may be used on shared or separate devices. In various embodiments transaction authorization codes may be entered through web-based interfaces or using mobile devices.

### CROSS REFERENCE TO RELATED APPLICATIONS

The present application claims benefit of U.S. Provisional Application No. 61/262,449, filed Nov. 18, 2009, the entire specification of which is hereby incorporated by reference in its entirety for all purposes, except for those sections, if any, that are inconsistent with this specification.

### TECHNICAL FIELD

Embodiments relate to systems and methods for facilitating transactions, and in particular to providing systems and methods that facilitate the consummation of transactions without the exchange of sensitive personal information.

### BACKGROUND

Identity and account theft and mismanagement have become prevalent. In particular, people find themselves facing a growing number of concerns when participating in transactions, both online and in person. Chief among these is the increasing need to share personal information when consummating transactions. Such information may include personal identifying information, such as name, social security numbers, addresses, etc. Such information may also include financial information, such as credit card numbers, bank account numbers, bank routing numbers, check information, etc.

While industries have evolved to provide protection against these problems, existing systems suffer from flaws. For example, while some payment systems allow users to conceal some personal and/or financial information, these systems may still utilize other identifying information, such as a party's email address. To a savvy hacker, this information may provide a way to acquire a party's personal information or to gain access to the party's financial information, such as on that payment service or on others.

### BRIEF DESCRIPTION OF THE DRAWINGS

Embodiments of the present invention will be readily understood by the following detailed description in conjunction with the accompanying drawings and flow charts. Embodiments of the invention are illustrated by way of example and not by way of limitation in the figures of the accompanying drawings.

FIG. 1 is a block diagram illustrating components of a secure transaction service provider as well as interactions between the secure transaction service provider and a buyer and seller;

FIG. 2 is a flowchart illustrating an exemplary process for creating a secure transaction account for a party;

FIG. 3 is an example interface for receiving user information and security question information from a party setting up an account;

FIGS. 4a and 4b are example interfaces for receiving account information for transactional accounts;

FIG. 5 is a flowchart illustrating an exemplary process for a buyer and a seller to complete a transaction using a shared device;

FIGS. 6a and 6b are example interfaces for requesting an obtaining a transaction authorization code for a seller party;

FIG. 7 is a flowchart illustrating an exemplary process for a buyer and a seller to complete a transaction using separate devices;

FIG. 8 is a flowchart illustrating an exemplary process for creating a secure transaction account for a merchant or seller;

FIG. 9 is a flowchart illustrating an exemplary merchant transaction process;

FIG. 10 is a flowchart illustrating an exemplary return processes; and

FIG. 11 is a block diagram illustrating a generalized example of a computing environment on which several of the described embodiments may be implemented.

All figures are ranged in accordance with various embodiments of the present disclosure.

### DETAILED DESCRIPTION OF EMBODIMENTS

In the following detailed description, reference is made to the accompanying drawings which form a part hereof, and in which are shown by way of illustration embodiments in which the disclosure may be practiced. It is to be understood that other embodiments may be utilized and structural or logical changes may be made without departing from the scope of the present disclosure. Therefore, the following detailed description is not to be taken in a limiting sense, and the scopes of embodiments, in accordance with the present disclosure, are defined by the appended claims and their equivalents.

Various operations may be described as multiple discrete operations in turn, in a manner that may be helpful in understanding embodiments of the present invention; however, the order of description should not be construed to imply that these operations are order dependent.

For the purposes of the description, a phrase in the form “A/B” or in the form “A and/or B” means (A), (B), or (A and B). For the purposes of the description, a phrase in the form “at least one of A, B, and C” means (A), (B), (C), (A and B), (A and C), (B and C), or (A, B and C). For the purposes of the description, a phrase in the form “(A)B” means (B) or (AB) that is, A is an optional element.

The description may use the phrases “in an embodiment,” or “in embodiments,” which may each refer to one or more of the same or different embodiments. The description may also use the phrases “in an implementation,” or “in an alternative implementation,” which may each refer to one or more of the same or different implementation details of various embodiments described herein. Furthermore, the terms “comprising,” “including,” “having,” and the like, as used with respect to embodiments or implementations of the present invention, are synonymous. The term “exemplary” is used herein merely illustrates that an example is being shown or described and is not intended to denote that any so-described feature is preferred or required over any other. Additionally, while flowcharts and descriptions of processes may make reference to particular steps, it should be understood that, in alternative implementations, the illustrated steps may be combined or divided into two or more sub-steps.

Various embodiments and implementations may include online transaction methods and systems that help preserve a user's anonymity and/or conceal personal information of parties to a transaction. By concealing information, the systems and methods may prevent fraud that could emanate from transactions. Embodiments may facilitate transactions between merchants and/or private parties who act as buyers and/or sellers.

In various embodiments, a system may use, for example, transaction authorization codes unique to each of the parties involved in a buying and selling transaction. In various embodiments, the authorization codes may be randomly generated, temporary, and/or single use codes.

In various embodiments, the transaction authorization code(s) may be exchanged between parties, and once confirmed or validated, the transaction may be consummated. In one embodiment, the transaction authorization code may conceal personal and/or financial information about a party with whom the code is associated. Further, because, in various embodiments, the code can be temporary and/or single use, use of the code may mitigate an amount of fraud damage to the associated party to a single occurrence in the event the code is compromised before it expires.

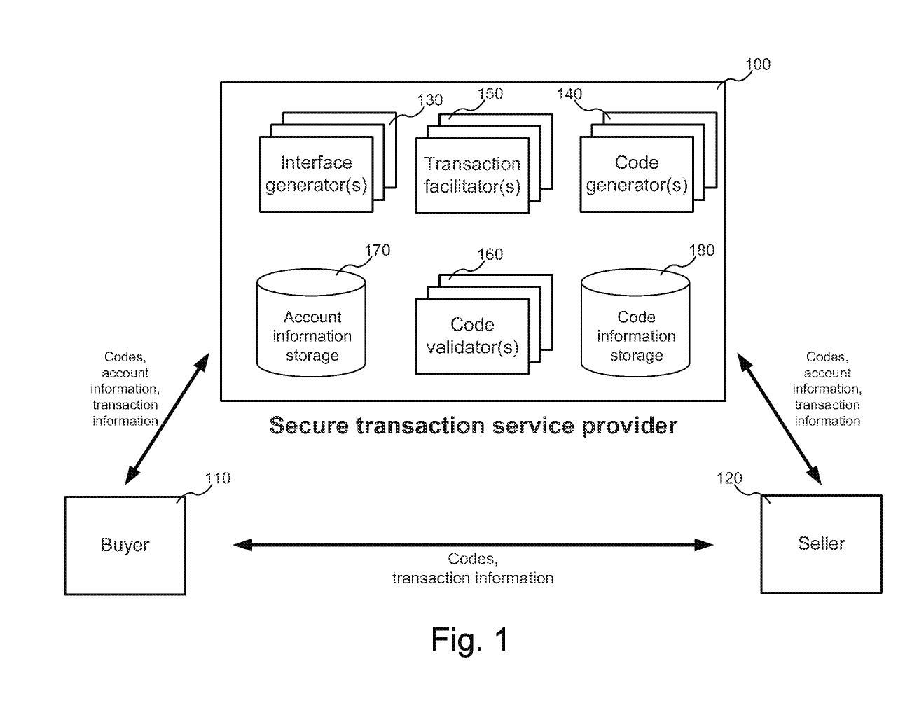

FIG. 1 is a block diagram illustrating components of a secure transaction service provider 100, as well as information flows between the secure transaction service provider 100 and an example buyer 110 and seller 120. While the example of FIG. 1 illustrates particular modules, storage units, and other entities, in various embodiments, the secure transaction service provider 100 may omit one or more of these features, may combine illustrated features and/or may comprise additional features which are not illustrated. While only one buyer 110 and seller 120 are illustrated in various embodiments the secure transaction service provider 100 may interact with multiple buyers and/or sellers.

As illustrated in the example of FIG. 1, the secure transaction service provider 100 may interact with a buyer 110 and a seller 120. In various embodiments, the buyer 110 and the seller 120 may be one or more of various types of parties who wish to participate in transactions, including individuals, merchants, companies, etc. In various embodiments, the buyer 110 and/or the seller 120 may interact with the secure transaction service provider 100 through one or more interfaces provided by the secure transaction service provider 100. In various embodiments, the secure transaction service provider 100 provides these interfaces through one or more interface generator modules 130. In one embodiment, generated interfaces may comprise web pages. In other embodiments, the secure transaction service provider 100 may interact with the buyer 110 and/or seller 120 through non-web interfaces, such as through mobile applications, text messaging, voice protocols, through network-based APIs, or through other interfaces. In various embodiments, as will be described herein, the buyer 110 and the seller 120 may interact with the secure transaction service provider 100 through the interface generator modules 130 to create and maintain accounts with the secure transaction service provider 100. In other embodiments, the buyer 110 and the seller 120 may interact with the secure transaction service provider 100 to receive transaction authorization codes from the secure transaction service provider 100, or to transmit transaction authorization codes to the secure transaction service provider 100. In various embodiments, the interface generator modules 130 may also act to allow the passing of other transaction information, such as transaction amounts or descriptions between the secure transaction service provider 100 and the buyer 110 and the seller 120. Additionally, in various embodiments, the buyer 110 and the seller 120 may themselves interact with each other without using the secure transaction service provider 100 as an intermediary. For example, the seller 120 may directly share a seller's transaction authorization code with the buyer 110, as described below.

In various embodiments, the buyer 110 and/or seller 120 may interact with the secure transaction service provider 100 through one or more devices. For example, interactions with the secure transaction service provider 100 may occur through a computer, through a mobile device such as a phone, PDA, tablet, or other mobile device, or through a dedicated device, such as a sales terminal. In various embodiments, the buyer 110 and/or seller 120 may interact with the secure transaction service provider 100 through a web browser, or a dedicated application, such as a mobile application running on a computer or a mobile device. In various embodiments, one or more devices used by the buyer 110 and/or the seller 120 may comprise radio frequency identification devices (“RFIDs”) or near-field communications devices (“NFCs”) which may allow the buyer and/or seller to communicate with each other or with the secure transaction service provider 100 via a short-distance wireless connection. In other embodiments, other wireless or wired connectivity may be used, such as, for example, a wifi or wireless modem connection, or other forms of communication.

The secure transaction service provider 100 may also comprise one or more code generator modules 140. In various embodiments, the code generators may generate transaction authorization codes for buyers and sellers. Embodiments of code generation are discussed in greater detail below. The secure transaction service provider 100 may also comprise one or more code validator modules 160. In various embodiments, the code validator modules may receive transaction authorization codes from buyers and/or sellers and determine whether the codes are valid. Embodiments of transaction authorization code validation are described in greater detail below. In various embodiments, both the code generator modules 140 and the code validator modules 160 may interact with an code information storage 180 to store and/or retrieve transaction authorization codes. Similarly, the interface generators 130 may interact with the account information storage 170 to store and/or retrieve account information for the buyer 110 and/or the seller 120.

Although the systems and methods described herein may be applied to many types of buying and selling transactions, for the purpose of clearer description, the description provided herein is focused on two types of example transactions. In the first type of example transaction, neither the seller or buyer is a merchant. This type of transaction may be referred to as a private party transaction. In the second type of example transaction the seller may be a merchant and the buyer may be a private party. This type of transaction may be known as a merchant transaction.

### Examples of Private Party Transactions

In various embodiments, private party transactions are transactions that do not involve a merchant. This type of transaction may include, for example, buying or selling an item using a classified ad, such as from a newspaper or classified ad website. In various scenarios, this type of transactions can pose several challenges to both the buyer and seller. These challenges can be especially troubling when the value of the transaction exceeds a few hundred dollars. In various scenarios challenges may include:
Sellers may not accept personal checks, requiring buyers to pay in cash or with a cashiers check;
Buyers may not be able to quickly get cash, such as when participating in a transaction after banking hours and/or when exceeding the buyer's ATM limit. This may cause a buyer to lose out on a deal;
Sellers may not accept credit cards;
Buyers and sellers may be hesitant to meeting a stranger carrying large sums of cash;
Sellers may be concerned about counterfeit cashiers' checks or cash;
Buyer and sellers may not want to give personal or financial information (such as an email address or payment service account information) to a stranger to transfer money.

In various embodiments, the methods and systems described herein may provide various benefits, including, but not limited to:
Reducing the need to go to a bank or ATM, as funds may be transferred directly from buyer's bank account or credit card;
Allowing a buyer to use a credit card to finance the transaction if necessary without requiring that the buyer present credit card information to a seller;
Allowing a buyer to get the deal conveniently, when time delays would otherwise cause a deal to be lost;
Lessening the need to carry cash when meeting a stranger; and
Preserving privacy, which reduces the opportunity for identity or account theft.

In various embodiments, before being involved in a transaction, the secure transaction service provider 100 may generate an interface to set a private party up with an account with the secure transaction service provider 100. The interface may include user interface elements for providing personal and/or financial information to the service provider to allow the service provider to make a unique account for the private party and link the account to a payment method. In various embodiments, payment methods may include one or more credit cards, checking accounts, or other sources of funds. Once verified, the private party's chosen account name, number or other unique identifier may be activated. In various embodiments, an example list of information that may requested by the interface may include, but is not limited to, some or all of the following:
name information;
an alias (In various embodiments, the alias may comprise a name that the party setting up the account may use transactions to preserve anonymity.);
address information;
unique identifier information, such as a Social Security Number or other identifier;
birth date;
bank account information, including routing number, account number, user name, and/or password
credit card information, including name, billing address, account number, expiration date; security code; user name, and/or password;
email address;
a choice of a security image;
user name;
password;
PIN;
answers to one or more security questions;
telephone numbers information for the party;
preferences for how to receive codes, such as via email, text message, or both;
choice of which payment option to set as a default payment option;

In various embodiments, the secure transaction service provider 100 may verify that the SSN, credit card, account numbers, etc, are not already being used by another user on the system and/or are properly linked to the identified party.

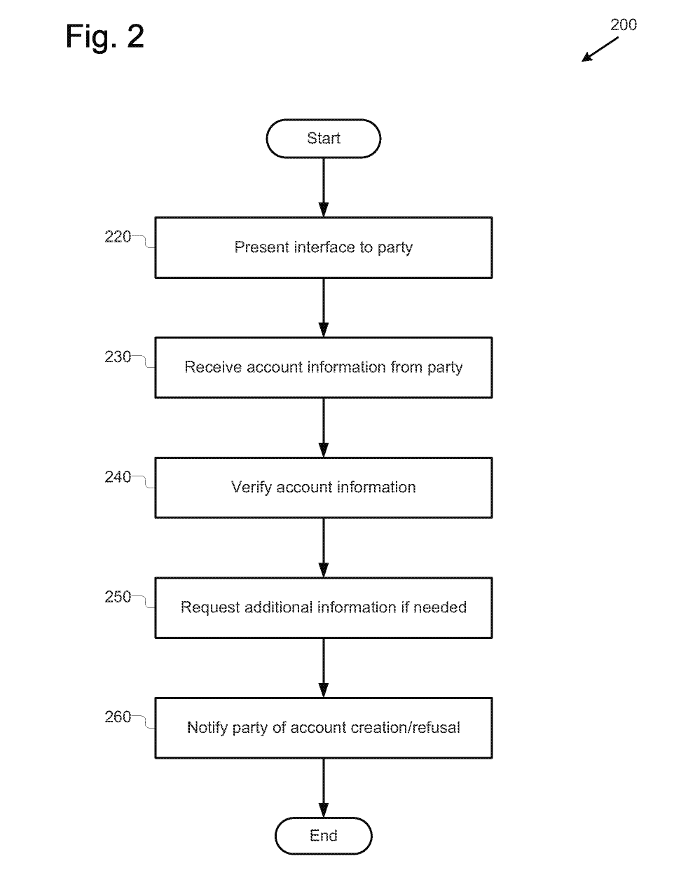

FIG. 2 is a flowchart illustrating an exemplary process 200 for a party, such as a buyer or a seller, to set up an account with the secure transaction service provider 100. In various embodiments, one or more of the operations illustrated in FIG. 2 may be combined, split into multiple operations, or omitted altogether. The process may begin at operation 220, where the secure transaction service provider 100 provides an account setup interface to the party. The interface may be provided, in various embodiments, by the interface generator module or modules 130. At operation 230, the secure transaction service provider 100 may receive account information from the party. In various embodiments, account information may include personal or identifying information for the party setting up the account. In various embodiments, the account information may include information which allows the secure transaction service provider 100 to interact with one or more financial or other transactional accounts the party has with outside transactional providers.

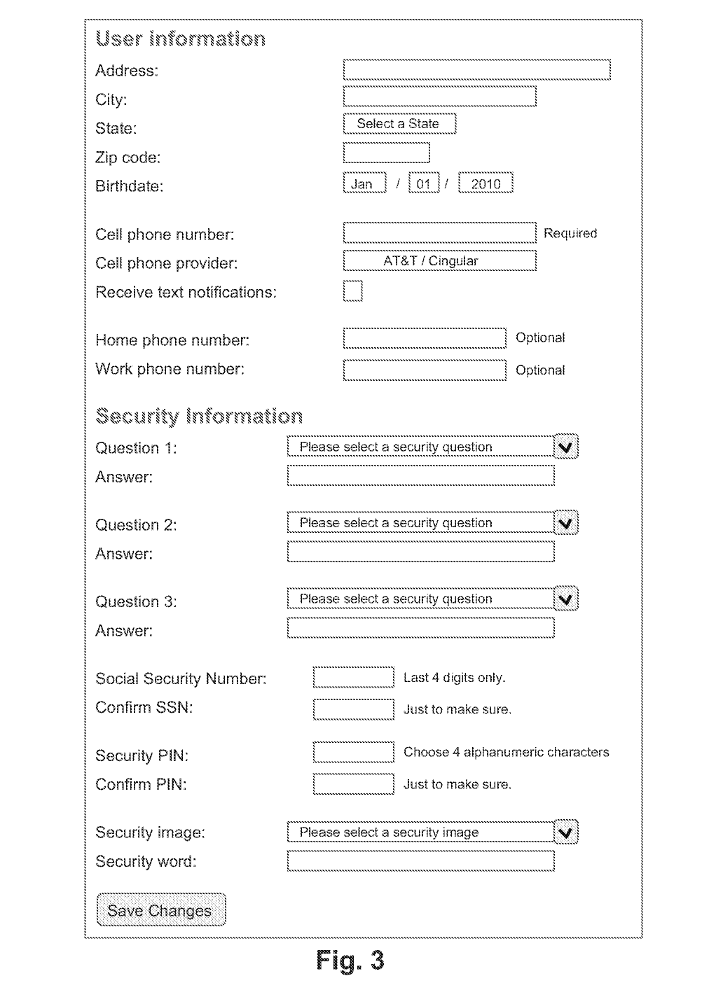

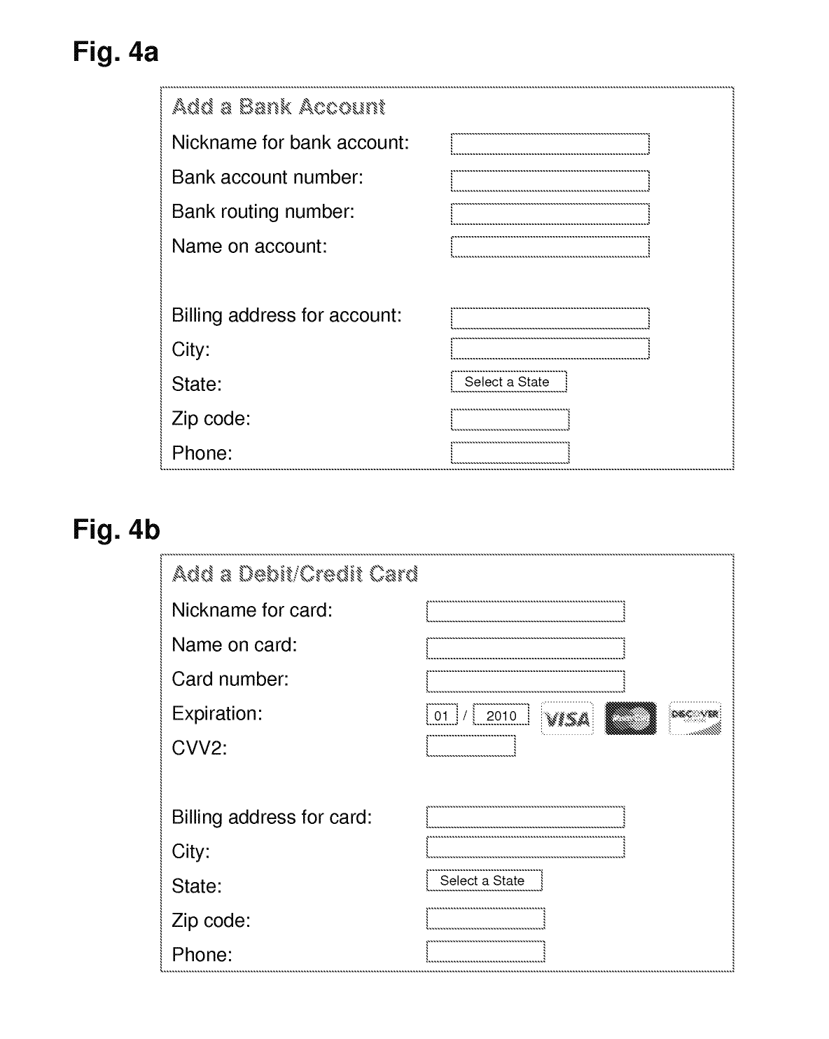

Examples of interfaces for receiving information from the party may be seen at FIGS. 3, 4a, and 4b. FIG. 3 is an example interface for receiving user information and security question information from a party setting up an account. As FIG. 3 illustrates, and as discussed above, in various embodiments, the interface provided to the party may request address information, contact information such as phone numbers, security information, such as answers to one or more security questions, and personal information, such as social security numbers and/or PINS. In some embodiments, the party may be provided with an opportunity to select a security image at the time of set up of the account. After selection, the image may be provided when the party is interacting with the secure transaction service provider 100 so that the party can trust that he or she is interacting with a trusted system. Similarly, in some embodiments, a security word may be provided during the account set up process. This security word may be provided during interactions with the secure transaction service provider 100, such as by including the word in a text message or email received from the secure transaction service provider 100 to prove the message is from a trusted source.

FIGS. 4a and 4b are example interfaces for receiving account information for transactional accounts which the secure transaction service provider 100 may interact with when completing transactions for the party setting up the account. Thus, for example, FIG. 4a illustrates an interface for setting up a bank account. In various embodiments, the secure transaction service provider 100 may request, though the interface, a nickname for the account, account and/or routing numbers, the name for the account, and/or the billing address for the account. In another example, FIG. 4b illustrates an interface for setting up a credit card account with the secure transaction service provider 100. In various embodiments, the secure transaction service provider 100 may request, though the interface, a nickname for the card, the name on the card, the card number, the expiration date and/or security code for the card, and billing information for the card.

Returning to FIG. 2, at operation 240, secure transaction service provider 100 may verify the account information provided by the party. In various embodiments, the verification may be performed by the one or more transaction facilitator module(s) 150. In various embodiments, the secure transaction service provider 100 may verify that the information provided is true. In other embodiments, the secure transaction service provider 100 may verify that sufficient funds or credit are available in a checking or credit card account to allow the party to participate in transactions. In various embodiments, at operation 240, the secure transaction service provider 100 may obtain the ability to deposit and/or withdraw funds from the checking or credit card account. At operation 250, if needed, the secure transaction service provider 100 may request additional information from the party setting up the account with the secure transaction service provider 100. In various embodiments, this request may be in response to a financial institution requesting additional information or simply declining access by the secure transaction service provider 100 to the financial account. Next, at operation 260, the secure transaction service provider 100 may notify the party if the account has been able to be activated or if it was refused.

Once the party has established an account with the service provider, in various embodiments the party may engage in and complete a transaction. In various embodiments, prior to meeting for a potential transaction, the buyer and seller may each log into their respective established accounts to obtain a transaction authorization code. In various embodiments, the transaction authorization code obtained by the seller may be referred to as a seller's transaction authorization code; similarly, the transaction authorization code obtained by the buyer may be referred to as a buyer's transaction authorization code. In various embodiments, these codes may be set to expire by the party who obtained them. For example, a transaction authorization code may be set to expire after a pre-set amount of time (e.g. 2 hours), after a single use, or after whichever occurs first. In various embodiments, the code may be sent to the requesting private party, such as by email, text message, etc.

In some embodiments, transaction authorization codes may contain a blank where the private party who obtained them can insert information, such as the party's personal identification number/code. Use of the blank may help protect the private party's transaction authorization code in case someone accesses the party's email or text message in which the party receives the code.

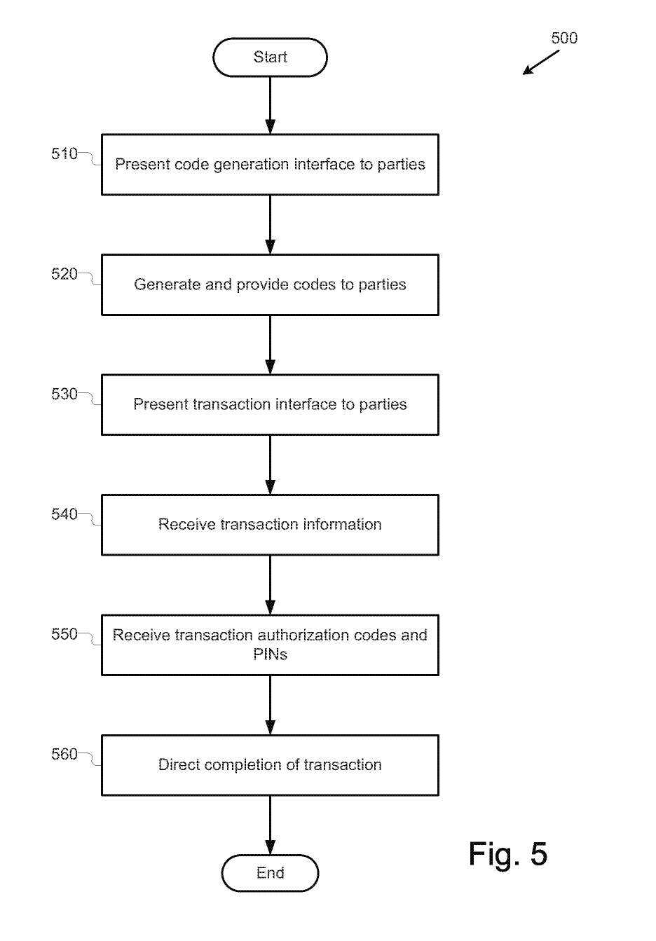

FIG. 5 is a flowchart illustrating an exemplary process 500 for parties, such as a buyer and a seller to participate in a transaction facilitated by the secure transaction service provider 100 using a shared computing device. In various embodiments, one or more of the operations illustrated in FIG. 5 may be combined, split into multiple operations, or omitted altogether.

The process may begin at operation 510, where, in various embodiments, the secure transaction service provider 100 may provide a code generation interface to one or more parties in order for the parties to obtain transaction authorization codes. For example, secure transaction service provider 100 may provide an interface to the buyer party in order for the buyer party to obtain a buyer's transaction authorization code. In various embodiments, the interface may request a user name from the buyer. In various embodiments, a new screen may then appear with the buyer's pre-selected security image. Use of the security image may let the buyer know that he/she is logging into the proper system and is not communicating with a forged interface. Next, the buyer may be prompted for a password. The buyer may have additional information requested of him or her, such as an approximate and/or maximum transaction amount, a time limit for the buyer's transaction authorization code to remain active, a description of an item or items potentially being purchased, and/or a selection of whether to bill the buyer's credit card or bank account for the transaction being prepared. In various embodiments, the secure transaction service provider 100 may enforce a maximum time for a buyer's code to remain active, such as a 24-hour limit.

In various embodiments, the secure transaction service provider 100 may also provide an interface to a seller party in order for the seller party to obtain a transaction authorization code. In various embodiments, the interface may request a user name from a seller. In various embodiments, a new screen may then appear with the seller's pre-selected security image. Use of the security image may let the seller know that he/she is logging into the proper system and is not communicating with a forged interface. Next, the seller may be prompted for a password. The seller may have additional information requested of him or her, such as an approximate and/or maximum transaction amount, a time limit for the seller's transaction authorization code to remain active, and/or a description of an item or items potentially being sold. In various embodiments, the secure transaction service provider 100 may enforce a maximum time for a seller's code to remain active, such as a 24-hour limit. In various embodiments, the secure transaction service provider 100 may provide the interfaces to the buyer and the seller at different times, as the provision of the buyer's and the seller's transaction authorization codes may be completely unrelated.

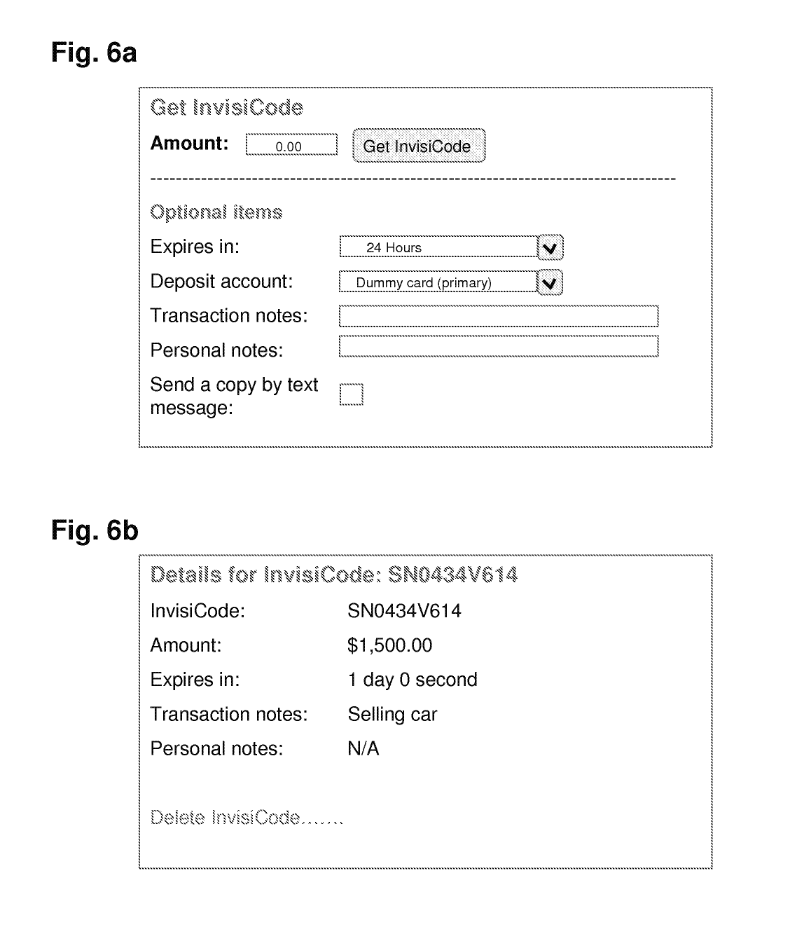

FIG. 6a is an example code generation interface for a seller party when obtaining a transaction authorization code. Thus, for example, as FIG. 6a illustrates, the code generation interface may request an amount for the transaction authorization code, an expiration time period, a selection of an account in which money may be deposited at the completion of the transaction, as well as notes and a selection to send a copy of the transaction authorization code via text message when it has been generated.

Next, at operation, 520, the secure transaction service provider 100 may generate transaction authorization codes, such as buyer's and seller's transaction authorization codes, and transmit these to the parties. In various embodiments, the transaction authorization codes may comprise letters, numbers, or combinations thereof. In various embodiments transaction authorization codes may vary in length, making them more difficult to guess than codes with a preset, fixed length. In various embodiments, the transaction authorization codes may comprise a blank where a buyer or seller's PIN may be entered. Thus, for the example of a buyer's code B34798AZZ3567S_{—}24438Z8D01IXQ, and a PIN 1111, the complete code would be B34798AZZ3567S111124438Z8D01IXQ. In various embodiments, the PIN length may differ by the party obtaining the code. The combination of the varying the length of the transaction authorization code and/or the length of the PIN may help conceal the PIN within the completed code. This may prevent detection of the party's PIN by snooping third parties. In various embodiments, the transaction authorization code may be provided to a requesting party in various ways, including via email, on a web page, or via text message. In various embodiments, the code generation module(s) 140 may store the generated code, along with associated information in the code information storage 180.

FIG. 6b is an example code provision interface for a seller party when obtaining a transaction authorization code. Thus, for example, as FIG. 6a illustrates, the code provision interface may provide a code (here “SN0434V614”), and display information associated with that transaction authorization code. The interface may also provide an element for selecting to delete the code.

Returning to FIG. 5, after the buyer and seller determine they wish to complete a transaction, such as after meeting or other discussion, at operation 530 the secure transaction service provider 100 may provide an interface for completing a transaction. In some embodiments, the interface for completing the transaction may be a website provided by the secure transaction service provider 100. At operation 550, in various embodiments, the secure transaction service provider 100 may receive the seller's transaction authorization code and the buyer's authorization code. In various embodiments, at operation 550 the secure transaction service provider 100 may also receive one or both PINs from the seller and/or the buyer. In various embodiments, the secure transaction service provider 100 may also receive additional information, such as a transaction amount. For example, the buyer and seller may determine to complete the transaction for a different amount than original contemplated when one or both of the transaction authorization codes were generated.

In various embodiments, the received transaction authorization codes may be checked for validity, such as by the one or more code validator modules 160. In some embodiments, checking for validity may comprise querying the code information storage 180 to determine if the codes have been previously generated. In some embodiments, once the transaction authorization codes are received from the buyer and the seller, the received codes are presumed invalid and may no longer be used again. In another example, the secure transaction service provider 100 may check to determine if one or both transaction authorization codes have exceeded a time limit, such as a time limit directed by one of the parties, or a system-wide time limit. If this time limit is exceeded, the transaction may not complete. In one embodiment, if a time limit is exceeded for one transaction authorization code but not for the other, the other, still-active code may be re-used in a different transaction. In some embodiments, after entering the transaction authorization codes, the buyer and the seller may receive confirmation communications, such as through email or text message. These communications may comprise pre-selected security images or words which may be other than those previously presented by the secure transaction service provider 100. The seller and/or buyer may confirm their participation in the transaction at this point by providing their PINs to the secure transaction service provider 100.

At operation 560, the secure transaction service provider 100 may direct completion of the transaction. In various embodiments, operation 560 may comprise the one or more transaction facilitator modules 150 utilizing account information stored in the account information storage 170 to perform completion of a financial transaction. In various embodiments, completion of the transaction may be subject to one or more limitations. For example, if, during completion, the buyer does not have sufficient funds in his or her account, the transaction may not complete.

In various embodiments, during operation 560, the secure transaction service provider 100 may provide an interface to one or both parties showing that the transaction is being consummated. For example, the secure transaction service provider 100 may display a transaction amount, a description of the item or items potentially being purchased, notes, and/or comments. Additionally, the secure transaction service provider 100 may provide an indication of the seller's and/or buyer's transaction authorization code(s). The interface may then allow the buyer and seller to confirm that the transaction is to be consummated.

In one embodiment, after acknowledgement, funds associated with the transaction may be credited to the seller's account and both parties may receive an email and/or text message indicating the transaction amount. In various embodiments, the parties may also receive a transaction consummation code and/or notification of the transaction amount via text and/or email. In various embodiments, the transaction consummation codes may comprise letters, numbers, or combinations thereof. The process of FIG. 5 may then end.

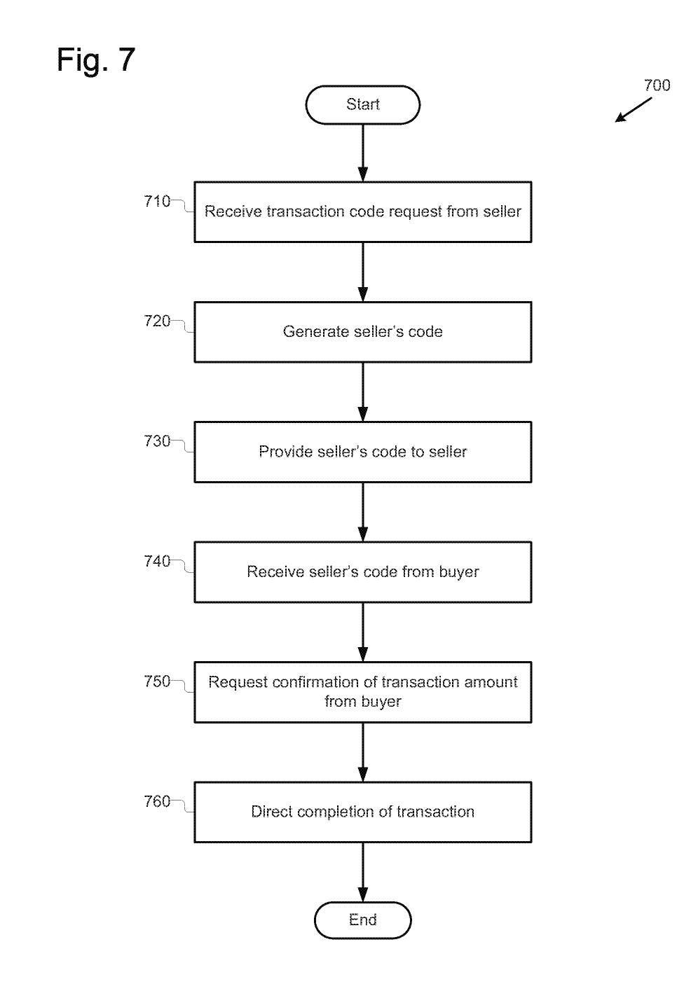

FIG. 7 is a flowchart illustrating an exemplary process 700 for parties, such as a buyer and a seller to participate in a transaction facilitated by the secure transaction service provider 100 using separate computing devices. In various embodiments, one or more of the operations illustrated in FIG. 7 may be combined, split into multiple operations, or omitted altogether. While embodiments described above are focused on transactions where a buyer and seller share the same terminal or mobile device to complete a transaction, in various scenarios, a buyer and seller may each have access to their own terminal or mobile device.

The process may begin at operation 710, where, in various embodiments, the secure transaction service provider 100 may receive a request from a seller for a seller's transaction authorization code. In various embodiments, operation 710 may comprise a seller logging into his or her account through an interface provided by the secure transaction service provider 100 and inputting a transaction amount. In various embodiments, the interface presented to the seller and information requested through the interface may be ranged in accordance with embodiments described elsewhere herein.

At operation 720, the secure transaction service provider 100 may generate a seller's transaction authorization code, and may provide that seller's transaction authorization code to the seller at operation 730. At operation 740, the secure transaction service provider 100 may receive the seller's transaction authorization code from a buyer. In various embodiments, operation 740 may comprise the seller giving the seller's transaction authorization code to the buyer, the buyer logging into his account on the secure transaction service provider 100, and the buyer inputting the seller's transaction authorization code. In various embodiments, the buyer may perform logging in and inputting the code on his or her own terminal/device. In various embodiments, the interface provided to the buyer may request information such as a user name, password, and the seller's transaction authorization code as provided by the seller. The interface may also present a security word or image, as discussed above.

In some embodiments, when completing a separate device transaction with a mobile phone/device, logging in with a username and password may be time consuming, especially in a retail setting. Therefore, in one embodiment, the user may launch a mobile app that uses the phone's or device's unique device identifier as the username and the user PIN as the password. After launching the app, the buyer may enter the seller's transaction authorization code. The buyer may then see the transaction amount and possibly the seller name. In various embodiments, the buyer may alter the transaction amount, such as by adding a tip in a restaurant, or reduce the amount, such as for a scratched item in a private party transaction. The buyer may then authorize payment by entering his or her PIN.

In another embodiment, the buyer may utilize an NFC- or RFID-enabled mobile device near a seller's NFC/RFID device. The seller's device may then transmit the seller's transaction authorization code to the buyer's device. Once the seller's transaction authorization code is transmitted to the buyer, the process may proceed as discussed above. In various embodiments, when authorization is sent to the secure transaction service provider 100 from the buyer, the buyer may be identified by his phone or device's unique device identifier.

In various embodiments, operation 740 may comprise checking the received transaction authorization code for validity, such as by the one or more code validator modules 160. In some embodiments, checking for validity may comprise querying the code information storage 180 to determine if the code has been previously generated. In another example, the secure transaction service provider 100 may check to determine if the transaction authorization code have exceeded a time limit. If this time limit is exceeded, the transaction may not complete.

At operation 750 the secure transaction service provider 100 may send a notification of the transaction to the buyer and request confirmation of the transaction. In various embodiments, the notification of the transaction may comprise the amount previously input by the seller. In various embodiments, the notification may comprise a description of the transaction. The secure transaction service provider may provide an interface for the buyer to confirm the amount and complete the transaction directly from the buyer's account without obtaining a separate buyer's transaction authorization code. Upon receiving confirmation from the buyer, at operation 760, the secure transaction service provider 100 may direct completion of the transaction. In various embodiments, operation 760 may comprise the one or more transaction facilitator modules 150 utilizing account information stored in the account information storage 170 to perform completion of a financial transaction. In various embodiments, funds may be credited to the seller's account and both parties may receive an email and/or text message indicating the transaction amount, as well as a transaction consummation code. In various embodiments, aspects of the confirmation and the transaction consummation code may be performed in accordance with embodiments described above.

### Examples of Merchant Transactions

Systems and methods in accordance with various embodiments may also facilitate transactions between a private party and a merchant. In various embodiments, these transactions may be referred to as merchant transactions. In various scenarios, merchant transactions may include, for example, phone purchases, online purchases, or face to face purchases at retail locations. When buying something from a merchant, such as over the phone, a buyer may have concerns over providing the merchant the buyer's personal or financial information, such as credit card numbers, security codes, expiration dates, or the buyer's name, address, phone number, etc. These concerns may be particularly strong when the buyer does not know who is receiving the data. In various embodiments, the systems and methods described herein may enable a purchaser to consummate a transaction without providing some or all of this sensitive information to the merchant or the merchant's employee.

In various embodiments, before being involved in a transaction, the secure transaction service provider 100 may generate an interface to set a merchant up with an account with the secure transaction service provider 100. The interface may include user interface elements for the merchant to provide personal and/or financial information to the secure transaction service provider 100 to allow the secure transaction service provider 100 to make a unique account for the merchant and link the account to one or more funds receiving methods and/or one or more payment methods. In various embodiments, funds receiving and payment methods may include one or more credit cards, checking accounts, or other accounts or sources of funds. Once verified, the merchant's chosen account name, number or other unique identifier may be activated. In various embodiments, an example list of information that may requested by the interface may include, but is not limited to, some or all of the following:
name information;
address information, such as a corporate street address;
phone number information;
unique identifier information, such as a tax ID number or other identifier;
bank account information, such as a corporate bank account number;
credit card information;
a contact person for the merchant;
address, phone, and/or email information for the contact person;
a user name for the merchant;
password;
PIN; and
answers to one or more security questions.

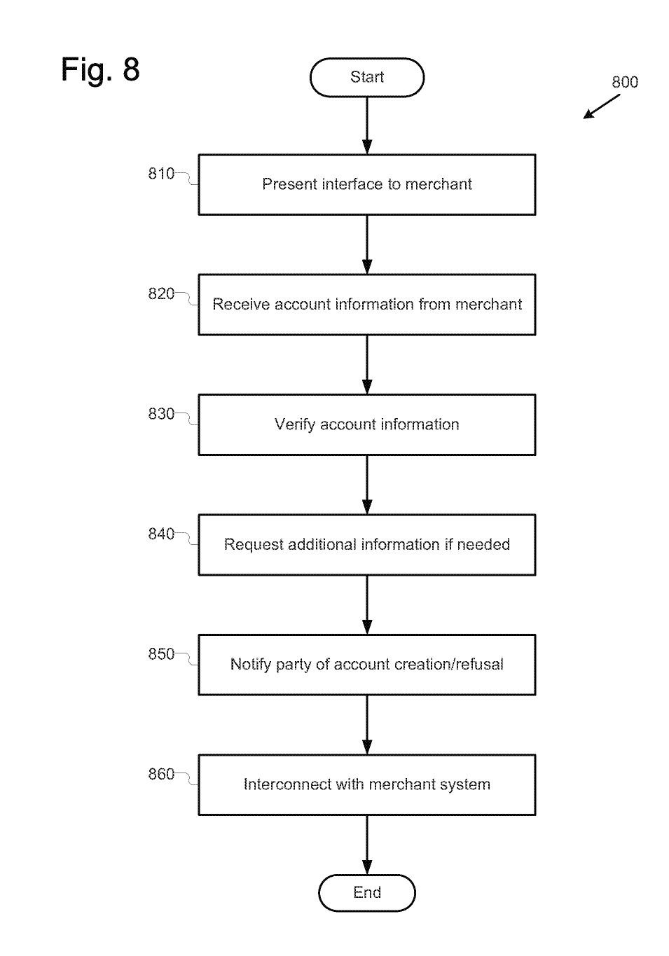

FIG. 8 is a flowchart illustrating an exemplary process 800 for a merchant to set up an account with the secure transaction service provider 100. In various embodiments, one or more of the operations illustrated in FIG. 8 may be combined, split into multiple operations, or omitted altogether. The process may begin at operation 810, where the secure transaction service provider 100 provides an account setup interface to the merchant; the interface may be provided, in various embodiments, by the interface generator module or modules 130. At operation 820, the secure transaction service provider 100 may receive account information from the merchant. In various embodiments, account information may include personal or identifying information for the merchant setting up the account. In various embodiments, the account information may include information which allows the secure transaction service provider 100 to interact with one or more financial or other transactional accounts the merchant has with outside transactional providers.

At operation 830, secure transaction service provider 100 may verify the account information provided by the merchant. In various embodiments, the verification may be performed by the one or more transaction facilitator module(s) 150. In various embodiments, the secure transaction service provider 100 may verify that the information provided is true. In various embodiments, at operation 830, the secure transaction service provider 100 may obtain the ability to deposit and/or withdraw funds from the checking or credit card account. At operation 840, if needed, the secure transaction service provider 100 may request additional information from the merchant setting up the account with the secure transaction service provider 100. In various embodiments, this request may be in response to a financial institution requesting additional information or simply declining access by the secure transaction service provider 100 to the financial account. Next, at operation 850, the secure transaction service provider 100 may notify the party if the account has been able to be activated or if it was refused. At operation 860, the secure transaction service provider 100 may attempt to interconnect with a system utilized by the merchant. In various embodiments, at operation 860, the merchant may be provided with software which allows for an interconnect between the secure transaction service provider 100 and the merchant's systems. The merchant may test the system and train employees in the use of the system. Once the interconnect is tested, the merchant account may be activated and the merchant may utilize the features of the systems and methods described herein.

In various embodiments, merchants may utilize transaction techniques like those described above as well as modified versions of the techniques. For example, in various embodiments, a merchant may not be provided with a temporary or single use seller's transaction authorization code or codes; instead the merchant may obtain a single, permanent pre-assigned merchant selling transaction authorization code. In some embodiments, the merchant may also be provided with a customer returns code as is described herein. In various embodiments, these provided merchant transaction authorization codes may be invisible to employee users at the merchant when integrated into the merchant's Point of Sale (“POS”) system. In various embodiments, merchants may be requested to provide additional information than the items indicated above. For example, in some embodiments, the additional information may include a copy of the merchant's articles of incorporation or other information typically required to establish a merchant credit card account.

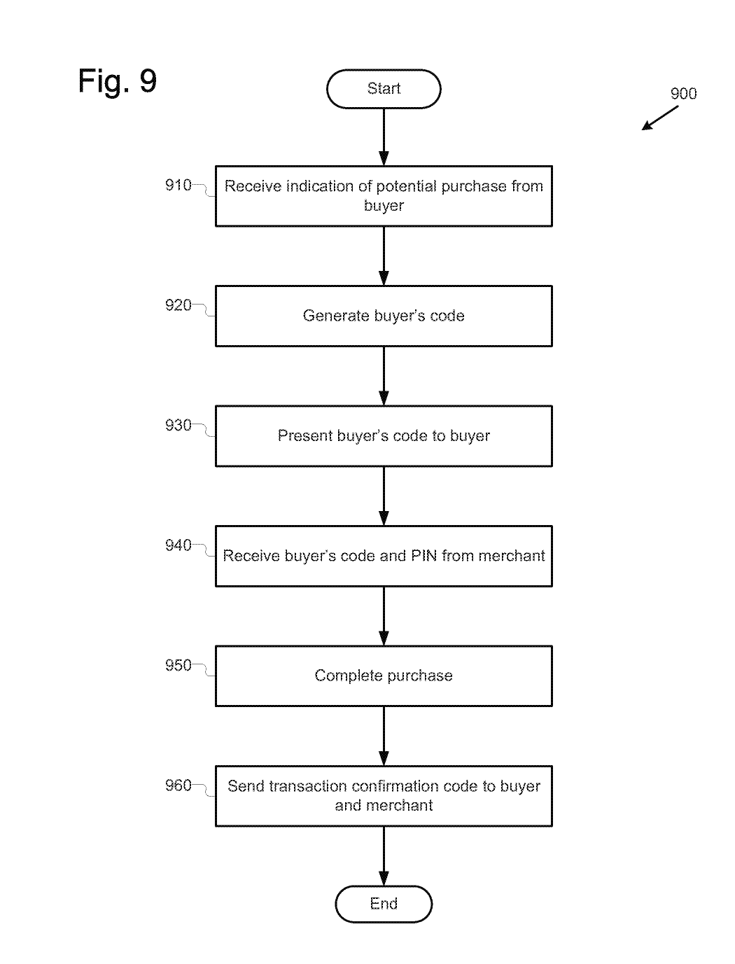

FIG. 9 is a flowchart illustrating an exemplary process 900 for a buyer party to participate in a transaction with a merchant as facilitated by the secure transaction service provider 100. While the examples described herein are given with reference to an example phone-based transaction, in various embodiments other merchant transactions may be provided for. In various embodiments, one or more of the operations illustrated in FIG. 9 may be combined, split into multiple operations, or omitted altogether. The process may begin at operation 910, where the secure transaction service provider 100 may receive an indication of a potential purchase from the buyer. In various embodiments, operation 910 may occur prior to the buyer calling a merchant (or during a call to a merchant) for a potential purchase. In various embodiments, the buyer may provide the indication to the secure transaction service provider 100 through an interface provided by the secure transaction service provider 100, where the buyer may log onto his or her account and obtain a buyer transaction authorization code.

In various embodiments, the interface may request a user name from the buyer. In various embodiments, a new screen may then appear with the buyer's pre-selected security image. As discussed above, use of the security image may let the buyer know that he/she is logging into the proper system and is not communicating with a forged interface. Next, the buyer may be prompted for a password. The buyer may have additional information requested of him or her, such as an approximate and/or maximum transaction amount, a time limit for the buyer's transaction authorization code to remain active, a description of an item or items potentially being purchased, and/or a selection of whether to bill the buyer's credit card or bank account for the transaction being prepared. In various embodiments, the secure transaction service provider 100 may enforce a maximum time for a buyer's code to remain active, such as a 24-hour limit.

At operation 920, the secure transaction service provider 100 may generate a buyer's transaction authorization code. Similar to the codes discussed above, in various embodiments, the buyer's transaction authorization code may be set to expire after a specified period, or after a single use, whichever occurs first. At operation 930, the secure transaction service provider 100 may present the buyer's transaction authorization code to the buyer. In various embodiments, the buyer's transaction authorization code may be presented via email and/or text message; in other embodiments, the code may be presented via a web page. As in the private party transactions discussed above, in some embodiments the code may contain a blank where the purchaser's PIN may be inserted for additional security. After placing the purchase order, the purchaser may provide the merchant the buyer's transaction authorization code. In various embodiments, if the buyer's transaction authorization code includes a blank for a PIN, the buyer may include the PIN as part of the complete code provided to the merchant. In various embodiments, because the location of the blank and the length of the PIN is unknown to the merchant, the merchant may not know which part of the code is the buyer's PIN.

At operation 940, the secure transaction service provider 100 may then receive the buyer's transaction authorization code and PIN from the merchant, such as after the merchant receives the same from the buyer. In various embodiments, the secure transaction service provider 100 may also provide a data collection interface to the merchant in order for the merchant to provide the buyer's transaction authorization code. In various embodiments, in addition to the buyer's transaction authorization code, the interface may request identifying information, such as an associate number or other identifier of the merchant's associate who is providing the code and/or the phone number from where the associate is calling. The merchant may have additional information requested of him or her, such as the buyer's name or alias, a recipient name and phone number, shipping information, a transaction amount, and/or a description of an item or items potentially being purchased.

In various embodiments, operation 940 may comprise checking the received transaction authorization code for validity, such as by the one or more code validator modules 160. In some embodiments, checking for validity may comprise querying the code information storage 180 to determine if the code has been previously generated.

At operation 950, the secure transaction service provider 100 may complete the purchase transaction, such as, for example, in the embodiments, described above. In various embodiments, operation 950 may comprise the one or more transaction facilitator modules 150 utilizing account information stored in the account information storage 170 to perform completion of a financial transaction. In various embodiments, the completion of the transaction may involve the secure transaction service provider 100 running tests for fraud, and or identifying and/or flagging errors or typos in the buyer's order. In other embodiments, at operation 960, the secure transaction service provider 100 may send confirmation, such as, for example, an email and/or text message indicating the transaction amount and a transaction confirmation code. In various embodiments, the buyer may retain the transaction confirmation code and may use the code to return the item and have charges reversed through the secure transaction service provider's 100 system. In various embodiments, for purchases that involve the merchant shipping the purchased item, when the merchant ships the item, a second email/text containing shipper and tracking number information may be conveyed to the buyer. As may be noted, in various embodiments a merchant transaction may be facilitated by having the merchant provide a merchant or seller's transaction authorization code to the buyer, rather than the buyer providing a buyer's transaction authorization code to the merchant as described above.

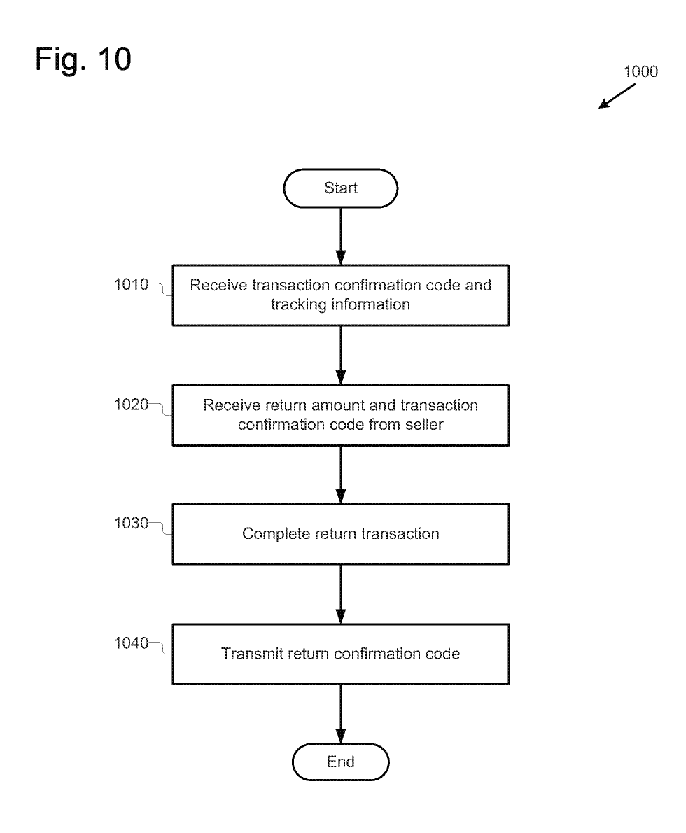

Once a purchase has been made from a merchant, buyers wishing to return one or more items may utilize the system and method described herein for their return. FIG. 10 is a flowchart illustrating an exemplary process 1000 for a buyer party to participate in a return transaction with a merchant as facilitated by the secure transaction service provider 100. While the examples described herein are given with reference to an example phone-based return transaction, in various embodiments other merchant transactions may be provided for. In various embodiments, one or more of the operations illustrated in FIG. 10 may be combined, split into multiple operations, or omitted altogether. Thus, in various embodiments, before the process has begun, the buyer may have called the merchant and follow the merchant's pre-established guidelines for returning purchased items.

The process may begin at operation 1010, wherein, in addition to following the merchant's pre-established guidelines, the secure transaction service provider 100 may provide the buyer with an interface through which the buyer may log into their account and the secure transaction service provider 100 may receive a transaction confirmation code and tracking information. In various embodiments, the information received by the secure transaction service provider 100 may include a shipping carrier, tracking number, an approximate amount of the item or items being returned. In some embodiments, the buyer may also enclose their transaction confirmation code with the item or items being returned to the merchant.

In various embodiments, the interface may request a user name from the buyer. In various embodiments, a new screen may then appear with the buyer's pre-selected security image. As discussed above, use of the security image may let the buyer know that he/she is logging into the proper system and is not communicating with a forged interface. Next, the buyer may be prompted for a password. The buyer may have additional information requested of him or her, such as a description of the item or items being returned, an approximate return amount, shipping information, the transaction confirmation code, as discussed above, and/or a selection of whether to credit the buyer's credit card or bank account for the transaction being prepared.

At operation 1020, after the merchant receives the returned item, the secure transaction service provider 100 may provide the merchant with an interface where the merchant may log into the secure transaction service provider 100, may receive the return amount and the transaction confirmation code. In various embodiments, the interface may request a description of the item or items being returned, an approximate return amount, shipping information, the buyer confirmation associated with the purchase.

At operation 1030, the secure transaction service provider 100 may complete the return transaction. In various embodiments, funds may be credited to the buyer's account. At operation 1040, the secure transaction service provider 100 may transmit to the buyer an email and/or text message indicating a return confirmation code. In various embodiments, the communication from the secure transaction service provider 100 may also include the return amount. In various embodiments, funds, less any reimbursable fees, may be deducted from the merchant's account and the merchant may be transmitted the same return confirmation code given to the buyer, confirming the return.

In various embodiments, if the return is not for the entire purchase amount associated with the buyer's transaction authorization code, the buyer's transaction authorization code may remain active on the secure transaction service provider 100 and a lowered balance may be associated with the code in case the customer wants to return additional items associated with that code in the future. In various embodiments, each return may have a unique return confirmation code.

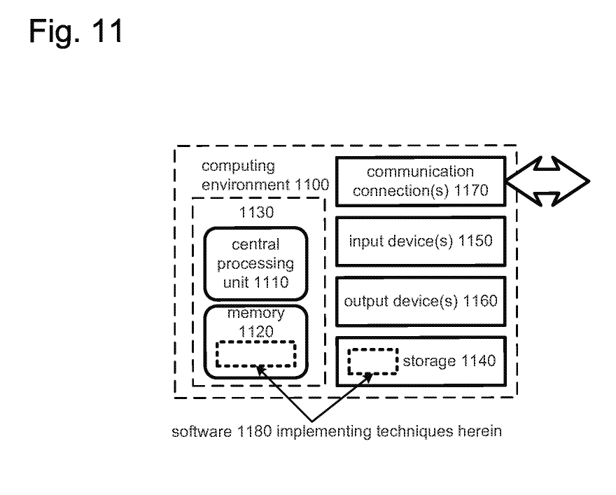

FIG. 11 illustrates a generalized example of a suitable computing environment (1100) in which several of the described embodiments may be implemented. The computing environment (1100) is not intended to suggest any limitation as to scope of use or functionality, as the techniques and tools may be implemented in diverse general-purpose or special-purpose computing environments such as personal computers, consumer electronic devices, and the like.

With reference to FIG. 11, the computing environment (1100) includes at least one CPU (1110) and associated memory (1120). In FIG. 11, this most basic configuration (1130) is included within a dashed line. The processing unit (1110) executes computer-executable instructions and may be a real or a virtual processor. In a multi-processing system, multiple processing units execute computer-executable instructions to increase processing power. The memory (1120) may be volatile memory (e.g., registers, cache, RAM), non-volatile memory (e.g., ROM, EEPROM, flash memory, etc.), or some combination of the two. The memory (1120) stores software (1180) implementing the techniques described herein.

A computing environment may have additional features. For example, the computing environment (1100) includes storage (1140), one or more input devices (1150), one or more output devices (1160), and one or more communication connections (1170). An interconnection mechanism (not shown) such as a bus, controller, or network interconnects the components of the computing environment (1100). Typically, operating system software (not shown) provides an operating environment for other software executing in the computing environment (1100), and coordinates activities of the components of the computing environment (1100).

The storage (1140) may be removable or non-removable, and includes magnetic disks, magnetic tapes or cassettes, CD-ROMs, DVDs, flash drives, disk arrays, or any other medium which can be used to store information and which can be accessed within the computing environment (1100). The storage (1140) stores instructions for the software.

The input device(s) (1150) may be a touch input device such as a keyboard, mouse, pen, or trackball, a voice input device, a scanning device, or another device that provides input to the computing environment (1100). For audio or video encoding, the input device(s) (1150) may be a sound card, video card, TV tuner card, or similar device that accepts audio or video input in analog or digital form, or a CD- or DVD-based drive that reads audio or video samples into the computing environment (1100). The output device(s) (1160) may be a display (e.g., monitor, display screen, or the like), printer, speaker, DVD-writer, or another device that provides output from the computing environment (1100).

The communication connection(s) (1170) enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

The techniques and tools can be described in the general context of non-transitory computer-readable media. Computer-readable media are any available media that can be accessed within a computing environment. By way of example, and not limitation, with the computing environment (1100), computer-readable media include memory (1120), computer-readable storage media (1140) (e.g., CDs, DVDs, diskettes, flash drives, removable hard drives, hard drive arrays), and combinations of any of the above.

The techniques and tools can be described in the general context of computer-executable instructions, such as those included in program modules, being executed in a computing environment on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing environment.

For the sake of presentation, the detailed description uses terms like “complete,” “query,” and “request” to describe computer operations in a computing environment. These terms are high-level abstractions for operations performed by a computer, and should not be confused with acts performed by a human being. The actual computer operations corresponding to these terms vary depending on implementation.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope of the present invention. Those with skill in the art will readily appreciate that embodiments in accordance with the present invention may be implemented in a very wide variety of ways. This application is intended to cover any adaptations or variations of the embodiments discussed herein. Therefore, it is manifestly intended that embodiments in accordance with the present invention be limited only by the claims and the equivalents thereof.

What is claimed is:

1. A computer-implemented method for facilitating a transaction, the method comprising:
receiving, by a computing device, information identifying a buyer who wishes to partake in a transaction;
verifying, by the computing device, an identity of the buyer;
receiving from the buyer, by the computing device, a unique transaction authorization code which is associated with a seller and a transaction;
verifying, by the computing device, that the unique transaction authorization code is valid; and
completing, by the computing device, the identified transaction between the buyer and the identified seller.

2. The method claim 1, wherein receiving information identifying the buyer comprises receiving an identification of a device associated with the buyer.

3. The method of claim 2, wherein receiving an identification of a device associated with the buyer comprises receiving a communication from a near field communications or radio-frequency identification device associated with the buyer.

4. The method of claim 1, wherein receiving information identifying the buyer comprises receiving a personal identification number entered by the buyer.

5. The method of claim 1, further comprising providing, by a computing device, a web-based buyer-identification interface.

6. The method of claim 1, wherein receiving information identifying the buyer comprises receiving login and password information for the buyer.

7. The method of claim 1, wherein:
the unique transaction authorization code is associated with a first transaction amount;
the method further comprises presenting, by the computing device, the first transaction amount to the buyer; and
completing a transaction between the buyer and the identified seller comprises completing, by the computing device, a monetary transaction between the buyer and the identified seller for the first transaction amount.

8. The method of claim 7, further comprising receiving, by the computing device, a second transaction amount from the buyer; and
wherein completing a transaction between the buyer and the identified seller comprises completing, by the computing device, a monetary transaction between the buyer and the identified seller for the second transaction amount.

9. The method of claim 1, wherein:
the unique transaction authorization code is associated with a time limit; and
completing a transaction between the buyer and identified seller comprises:
determining, by the computing device, whether the computing device has received the unique transaction authorization code within the time limit; and
if computing device has received the unique transaction authorization code within the time limit, the computing device completing the transaction.

10. The method of claim 1, further comprising:
receiving, by the computing device, an identification of the seller and the transaction; and
generating, by the computing device, the unique transaction authorization code to be associated with the seller and the transaction.

11. The method of claim 10, further comprising:
receiving, by the computing device, an identification of a transaction amount; and
generating the unique transaction authorization code further comprises the computing device generating the unique transaction authorization code based at least in part on the identification of the transaction amount.

12. The method of claim 10, wherein:
generating the unique transaction authorization code further comprises the computing device generating the unique transaction authorization code to have one or more blanks in it;
receiving a unique transaction authorization code comprises receiving, by the computing device, the unique transaction authorization code with the one or more blanks filled in with personal identifying information from the buyer; and
verifying that the unique transaction authorization code is valid comprises the computing device verifying the generated unique transaction authorization code and the personal identifying information.

13. A computer-implemented method for facilitating a transaction, the method comprising:
transmitting, by a computing device, a unique seller transaction authorization code to a seller for a specified transaction;
transmitting, by the computing device, a unique buyer transaction authorization code to a buyer for the specified transaction;
providing, by the computing device, an interface for entering transaction authorization codes;
responsive to receiving the buyer transaction authorization code and the seller transaction authorization code through the interface, determining whether the buyer transaction authorization code and the seller transaction authorization code are valid; and
responsive to determining that the buyer transaction authorization code and the seller transaction authorization code are valid, completing the transaction between the buyer and seller.

14. The method of claim 13, further comprising generating, by the computing device, the buyer transaction authorization code and the seller transaction authorization code.

15. The method of claim 13, wherein determining whether the buyer transaction authorization code and the seller transaction authorization code are valid comprises:
determining, by the computing device, whether one of either the buyer transaction authorization code or the seller transaction authorization code has been received by the computing device before; and
if either one of the buyer transaction authorization code or the seller transaction authorization code has been received by the computing device before, determining, by the computing device, that the previously-received transaction authorization code is invalid.

16. The method of claim 13, further comprising receiving, by the computing device, one or more personal identification numbers for the buyer and/or the seller through the interface.

17. A system for facilitating a transaction, the system comprising:
one or more computer processors;
a code information storage coupled to the one or more computer processors and configured to store one or more unique transaction authorization codes;
a code generator module configured, upon execution by the one or more processors, to generate a unique transaction authorization code associated with a seller and a transaction;
an interface generator module configured, upon execution by the one or more processors, to:
receive information identifying a buyer who wishes to partake in a transaction; and
receive from the buyer the unique transaction authorization code associated with the seller and the transaction;
a transaction facilitator module configured, upon execution by the one or more processors, to complete the identified transaction between the buyer and the seller.

18. The system of claim 17, wherein the interface generator module is further configured to receive an identification of a device associated with the buyer.

19. The system of claim 17, wherein:
a code generator module is further configured to associate the unique transaction authorization code with a first transaction amount; and
the interface generator module is further configured to:
present the first transaction amount to the buyer; and
receive a second transaction amount from the buyer; and
the transaction facilitator module is further configured to complete a monetary transaction between the buyer and the identified seller for the second transaction amount.

20. One or more computer-readable media which, responsive to execution by one or more computer processors, cause the processors to perform a computer-implemented method for facilitating a transaction, the method comprising:
receiving information identifying a buyer who wishes to partake in a transaction;
verifying an identity of the buyer;
receiving from the buyer a unique transaction authorization code which is associated with a seller and a transaction;
verifying that the unique transaction authorization code is valid; and
completing the identified transaction between the buyer and identified seller.

21. The computer-readable media of claim 20, wherein the method further comprises receiving an identification of a device associated with the buyer.

22. The computer-readable media of claim 20, wherein:
the unique transaction authorization code is associated with a first transaction amount; and
the method further comprises:
presenting the first transaction amount to the buyer;
receiving a second transaction amount from the buyer; and
completing a monetary transaction between the buyer and the identified seller for the second transaction amount.
